(19) United States
(12) Patent Application Publication
(10) Pub. No.: US 2014/0278609 A1
(43) Pub. Date: Sep. 18, 2014

(54) Payment System

(71) Applicant: Stephen Capps, San Carlos, CA (US)

(72) Inventor: Stephen Capps, San Carlos, CA (US)

(73) Assignee: PayNearMe, Inc., Sunnyvale, CA (US)

(21) Appl. No.: 14/212,589

(22) Filed: Mar. 14, 2014

Related U.S. Application Data
(60) Provisional application No. 61/852,486, filed on Mar. 15, 2013.

(51) Int. Cl. G06Q 20/20; G06Q 20/14

(52) U.S. Cl. CPC G06Q 20/208; G06Q 20/14
USPC 705/5; 705/23

(57) ABSTRACT

Disclosed herein are systems and methods to facilitate bill payments with a service provider system by: generating a unique token; providing the unique token to a user; receiving an indication from a retail location that the unique token was used on a first user device in conjunction with a payment associated with the unique token at a point-of-sale; marking the first user device as associated with the first unique token; providing active payment information to the first user device; receiving a request for payment information from a second user device; and providing inactive payment information to the second user device.

The present application claims the benefit of priority to U.S. patent application Ser. No. 61/852,486. Except for any term definitions that conflict with the term definitions provided herein, the following related, co-owned, and co-pending applications are incorporated by reference in their entirety: U.S. patent application Ser. Nos. 13/087,271; 13/123,067; 13/175,657; 13/209,291; 13/267,642; 13/298,179; 13/312,835; 13/479,135 and 13/542,374. And except for any term definitions that conflict with the term definitions provided herein, the following related, co-owned, and co-pending applications are incorporated by reference in their entirety: U.S. Patent Application Nos. 61/852,492, entitled “LOCATION BASED PAYMENTS” filed on Mar. 15, 2013 and 61/852,490, entitled “CASH BASED CHECK SYSTEM” filed on Mar. 15, 2013.

### BACKGROUND

Under some circumstances, it may be useful to allow for payment based on location of the payor. Typical systems require something such as an account number, statement, bill, invoice or the like to allow for payment processing. It may be advantageous to allow someone to pay a bill based on where the person is when requesting to pay the bill or when paying the bill.

Under some circumstances, it may be useful to allow for multiple devices to show information about a payment to be made at a retail location. However, it may also be useful to restrict access to evidence of a payment. In some circumstances, an unauthorized user may be able to access a device and get information about a payment made which allows the unauthorized user to cheat the paying customer out of goods and/or services.

### BRIEF DESCRIPTION OF THE DRAWINGS

The present invention is illustrated by way of example in the accompanying drawings. The drawings should be understood as illustrative rather than limiting.

FIG. 1 is a high-level flow process chart illustrating the relationships between the parties that partake in the presented systems and methods.

FIG. 2 is a high-level flowchart illustrating a method for facilitating transactions, in accordance with one embodiment presented herein.

FIG. 3 is a flowchart illustrating one embodiment presented herein.

FIG. 4 is a schematic drawing of a computer system used to implement the methods presented.

FIG. 5 is a screenshot of an embodiment of the present invention.

FIG. 6 is another screenshot of an embodiment of the present invention.

FIG. 7 is another screenshot of an embodiment of the present invention.

FIG. 8 is another screenshot of an embodiment of the present invention.

FIG. 9 is another screenshot of an embodiment of the present invention.

FIG. 10 is another screenshot of an embodiment of the present invention.

FIG. 11 is another screenshot of an embodiment of the present invention.

FIG. 12 is another screenshot of an embodiment of the present invention.

FIG. 13 is another screenshot of an embodiment of the present invention.

FIG. 14 is another screenshot of an embodiment of the present invention.

FIG. 15 is another screenshot of an embodiment of the present invention.

FIG. 16 is another screenshot of an embodiment of the present invention.

FIG. 17 is another screenshot of an embodiment of the present invention.

FIG. 18 is another screenshot of an embodiment of the present invention.

FIG. 19 is another screenshot of an embodiment of the present invention.

FIG. 20 is another screenshot of an embodiment of the present invention.

FIG. 21 illustrates processing a payment in an embodiment.

FIG. 22 illustrates a process of handling a payment in an embodiment.

FIG. 23 illustrates interactions involved in a payment in some embodiments.

FIG. 24 illustrates processing a payment in another embodiment.

FIG. 25 illustrates an example of a payment stub which may be used in some embodiments.

FIG. 26 illustrates a process of handling transactions for a merchant account with a payment book.

### DETAILED DESCRIPTION

A system, method and apparatus is provided for a payment system is provided. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

Embodiments of the present invention generally relate to systems and methods for facilitating transactions between a merchant-partner and an end-user. For example, the present invention provides a merchant-partner with a means for conducting a cash transaction via a remote point-of-sale (POS) terminal. The present invention is particularly useful in facilitating transactions such as: sale/purchase agreements, loan repayments, collections, money transfers, bill payments, remote deposits, etc. In one embodiment, a service provider and/or POS terminal serves as an intermediary between a merchant-partner and the end-user. The system allows the end-user to pay for the merchant-partner's goods/services/obligations in cash (or cash equivalents) at a POS terminal. The POS terminal and/or service provider then notifies the merchant-partner that the end-user has made a payment. After the merchant-partner has received a notification, validation, or otherwise confirmation of payment, the merchant-partner can securely complete the agreed upon transaction between the merchant-partner and the end-user.

However, in order for such system to be commercially viable, the systems and methods presented generally include the process steps of: (a) staging a transaction between the merchant-partner and the end-user; (b) tokenizing the transaction by linking one or more transaction instructions to one or more token IDs; (c) providing the end-user with the one or more token IDs, wherein the end-user can then present the token ID and a payment to a POS terminal; (d) receiving confirmation that the end-user has presented, to a POS terminal, the token ID and a payment in accordance with the one or more transaction instructions; (e) notifying the merchant-partner that the end-user provided the payment to the POS terminal; and (f) settling the transaction between the POS terminal and the merchant-partner. Similar systems and methods are discussed in more detail in the above-reference, co-owned, and co-pending applications, which have been incorporated by reference.

The present invention, expands on and further develops the systems and methods disclosed in the above-referenced applications. More specifically, presented herein are systems and methods for facilitating cash payment transactions using an end-user's mobile device. Amongst other things, the presented systems and methods provide a unique and effective way of providing the end-user with the token ID using the functionality of an end-user's mobile device. For example, in one embodiment, the systems and methods generally call for a service provider: (a) staging a transaction between a merchant and a consumer; (b) obtaining the consumer's contact information (e.g., the consumer's mobile telephone number or e-mail address); (c) creating a transaction-specific unique reference locator (URL) linked to a transaction-specific web page; and (d) sending the transaction-specific URL to the consumer. When the consumer accesses the transaction specific web page from a mobile device (e.g., via the transaction specific URL), the service provider: (e) displays a token ID on the transaction-specific web page. The token ID may be in the form of: a barcode, a pin number, and/or a quick response (QR) code. The token ID, which is linked to the staged transaction, is then used to initiate data communication between a POS terminal and the service provider's processing unit. The service provider can then: (f) receive confirmation that the consumer has presented the token ID and a payment to the POS terminal; (g) validate/verify the transaction; (h) display a transaction receipt on the transaction-specific web page; and/or (i) notify the merchant that the consumer has provided the payment.

Before describing the invention in more detail, it is appropriate to define certain terms and phrases. The terms “merchant” and “merchant-partner” are used interchangeably herein. It is noted that the term “merchant” and/or “merchant-partner” is not limited to entities that directly sell goods/services. For example, a merchant may be a loan service, collections service, money transfer service, bill payment service, bank deposit service, credit union, etc. The terms “consumer,” “customer,” and “end-user” are used interchangeably herein, and generally refer to a buyer of goods/services provided by a merchant. However, it is noted that the use of the systems and methods presented is not strictly limited to sale/purchase transactions between a seller and a buyer. The systems and methods presented may be used to facilitate transactions between: two or more individuals, an individual and one or more businesses, two or more businesses, etc. The systems and methods presented may also be used to facilitate transactions between any two or more parties that have a pre-existing relationship or obligation(s). The terms “point-of-sale,” “point-of-sale terminal,” “POS,” “POS terminal,” and “point-of-payment” are used interchangeably herein, and generally refer to the location where a payment is received from a consumer. It is also noted that terms such as “POS” or “POS terminal” may include the actual terminal where payment is presented and received (e.g., the cash register), or may include the POS back office, or any entity controlling one or more of the actual terminals. The terms “service provider” and “payment processor” are used interchangeably herein, and generally refer to the functional unit(s) for implementing the systems and methods presented. As used herein, a service provider may be an independent, stand-alone entity, or may be a functional sub-system of a merchant-partner and/or POS.

The following is a description of one or more embodiments of the present invention, with reference to FIGS. 1-20. It is to be understood that the present invention is not limited to the particular embodiments described. It is also to be understood that the terminology used herein is for the purpose of describing particular embodiments only, and is not intended to be limiting, since the scope of the present invention will be limited only by the appended claims.

FIG. 1 is a high-level flow process chart, illustrating the relationships between the parties that partake in the presented system 100. In general, system 100 includes four key parties: (1) service provider 102; (2) merchant-partner 104; (3) POS 106; and (4) end-user 108. The dashed lines in FIG. 1 generally represent a flow of information, data, or process between respective parties. In practice, the dashed lines in FIG. 1 represent user interfaces and/or application program interfaces (APIs) for the transmission of information, data, instructions, funds, etc.

As will be described further below, service provider 102 and POS 106 play a central role in facilitating transactions between merchant-partner 104 and end-user 108. In one embodiment, each party serves a stand-alone function within system 100. However, in an alternative embodiment, service provider 102 may be incorporated into, or be a functional unit of, merchant-partner 104 and/or POS 106. Further, merchant partner 104 may be any type of merchant, seller, or retailer; such as an online, web-based merchant, or catalog-based merchant. POS 106 (and/or POS terminal) may be a local retailer (e.g., relative to end-user 108), ATM, kiosk, or other cash-exchange terminal, intermediary, or equivalent thereof. POS 106 (and/or POS terminal) may be disclosed/identified to the end-user 108 via one or more of the systems described below, such as via a computer or smart phone connection to merchant-partner 104 or service provider 102.

In FIG. 1, process flow 120 and 122 represents an exchange between merchant partner 104 and end-user 108. In the example shown, merchant-partner 104 provides end-user 108 with a user-interface to purchase a goods/services. For example, the merchant may provide the user with a “checkout” experience over: a web page on a merchant's website; an interface on a mobile device; an interactive voice system over a telephone network; or any interface equivalent thereof. While known customer user interfaces may provide a “checkout” experience that allows an end-user to enter their credit card information, the system shown in FIG. 1 provides the end-user with a checkout experience that allows the end-user to pay for the goods/services in cash (or cash equivalents).

If the end-user selects to pay in cash, then merchant-partner 104 interfaces and exchanges information with service provider 102, as represented by process flow 124, 126. In practice, merchant-partner 104 and/or service provider 102 stages a transaction by linking a set of one or more transaction instructions to end-user 108. The transaction instructions may vary, but generally include instructions on what actions (e.g., payments) need to be performed by end-user 108 in order for merchant-partner 104 to provide end user 108 with the agreed upon goods/services (e.g., item 110). The transaction instructions may include actions to be performed by the end-user 108, merchant-partner 104, service provider 102, or any combination thereof.

Service provider 102 then “tokenizes” the staged transaction by linking the set of one or more transaction instructions to a token ID. (The terms “token,” “token ID,” “unique payment identifier,” and “PID” are used interchangeably herein.) In an alternative embodiment, a single token ID can be linked to multiple staged transactions and/or multiple merchant-partners. The token ID is then provided to end-user 108. The token ID can be provided to the end-user 108 either directly from service provider 102, POS 106, or merchant-partner 104. FIGS. 5-20 illustrate exemplary embodiments of how the token ID is provided to end-user 108 via an end-user mobile device.

When end-user 108 is ready to make a payment, end-user 108 presents the token ID to POS 106, along with an appropriate payment, as represented by process flow 128. At POS 106, the token ID serves as a means of linking the end-user's payment to the one or more transaction instructions. In other words, when end-user 108 presents the token ID and payment to POS 106, the token ID is used to initiate data communication between POS 106 and service provider 102, and thereby route the presentment information to service provider 102, as represented by process flow 130, 132. Service provider 102 may then validate that the presentment was in accordance with the transaction instructions linked to the token ID. If the end-user's payment is in accordance with the transaction instructions linked to the token ID, then service provider 102 notifies merchant-partner 104 that a payment has been made. Merchant-partner 104 then completes the transaction by, for example, shipping item 110 or otherwise fulfilling the transaction and/or crediting end-user's 108 account with merchant-partner 104. Service provider 102 then settles the transaction between merchant-partner 104 and POS 106 by receiving the payment funds (minus any agreed upon service fees) from POS 106, and delivering the payment funds (minus any agreed upon service fees) to merchant-partner 104.

In an alternative embodiment, the systems and methods described herein do not require merchant-partner 104 to provide end-user 108 with a checkout experience. There is also no requirement that the end-user provide an intent or selection of a cash payment option. For example, in one embodiment, merchant-partner 104 provides its customers with one or more tokens as a means for the customers to make payments. The payments can be made at a POS terminal, and a series of staged transactions may proceed, without any front-end involvement by end-user 108.

FIG. 2 is a high-level flowchart illustrating a method 200 for facilitating a transaction between a merchant-partner and an end-user, in accordance with one embodiment presented herein. More specifically, FIG. 2 is a flowchart generally illustrating the steps performed in the system described in FIG. 1. The method includes: (a) staging a transaction (step 201); (b) tokenizing the staged transaction (step 202); (c) receiving the presentment (step 203); (d) notifying the merchant-partner that the presentment has been received (step 204); and (e) settling the transaction between the parties (step 205). Additional details for steps (a)-(d) are provided in, for example, U.S. application Ser. Nos. 13/087,271; 13/123,067; and 13/312,835, which are incorporated by reference herein.

FIG. 3 is a flowchart illustrating one embodiment of the present invention. More specifically, FIG. 3 illustrates a method 300 for providing a consumer with the token ID created in step 202. In step 301, a transaction-specific URL is created and linked to a transaction-specific web page. In practice, the transaction-specific web page may be maintained on the service provider's server. Additionally, step 301 typically occurs after the transaction has been staged in step 201. As such, the transaction-specific URL and transaction-specific web page can also be linked to the staged transaction and/or token ID. In step 302, the consumer is provided with a prompt to enter their contact information. Such prompt can be provided on the merchant's web page, or by redirecting the consumer to the service provider's web page. The consumer's contact information can then be linked to the staged transaction. Alternatively, if the merchant is already in possession of the consumer's contact information, such contact information can be included in the staged transaction. Such contact information may include details such as mobile telephone numbers, e-mail addresses, instant messaging usernames, handles, etc. In step 303, the URL is sent to the consumer. Preferably, the consumer's contact information is used to lead the consumer into accessing/receiving the URL on their mobile device. For example, if a staged transaction includes a consumer's e-mail address and mobile telephone number, the service provider's processing system can select to send the URL to the consumer via a short message service (SMS) text message to their mobile phone. Alternatively, an e-mail can be sent, but the e-mail can ask the consumer to access the URL with their mobile device (be it a mobile phone, tablet, etc.).

In step 304, the service provider's processing unit determines whether the consumer clicked on the URL on a mobile device. If not, the service provider may continue a non-mobile implementation of the process steps of FIG. 2, as described in the above-referenced applications. However, if the consumer has chosen to access/receive the URL on a mobile device, the service provider's processing unit receives a user-agent string identifying the mobile device, and assess compatibility of the mobile device based on the user-agent string, in step 305. By assessing compatibility, the service provider's processing unit can adjust the text, type, format, etc., of the information that is presented to the consumer's mobile device. The service provider can also select/modify the token ID based on the compatibility of the consumer's mobile device.

In step 306, the service provider's processing unit can receive a geolocation from the mobile device, and identify one or more POS terminals that may be local to the consumer, based on geolocation. The one or more local POS terminals can then be provided to the consumer as a list (or as pin-points on a map), via the transaction-specific web page, in step 307. Alternatively, the consumer can enter their zip code, or a preselected POS terminal, and steps 306 and 307 can be skipped. In step 308, the service provider's processing unit determines whether the consumer selected a POS terminal for providing the payment and/or whether the consumer is at the POS terminal and ready to provide the payment.

In step 309, the token ID is displayed on the transaction-specific web page. The token ID serves as a means to initiate data communication between the POS terminal and the service provider's processing unit. The token ID is used by the service provider to identify the staged transaction, and allows the service provider to confirm whether or not the payment is consistent with the staged transaction instructions. For example, in the embodiment wherein the token ID is a barcode, the POS terminal attendant scans the barcode and the POS terminal recognizes that the barcode requires an application programming interface (API) call to the service provider's processing unit. In step 310, the service provided receives confirmation from the POS terminal that the consumer has presented the token ID and the payment to the POS terminal; i.e., the service provider receives “presentment data” from the POS terminal. With said presentment data, the service provider can validate or otherwise verify the transaction and payment, as in step 311. Because the consumer is using their mobile device to display the token ID on the transaction-specific web page, the service provider can refresh the transaction-specific web page upon verification of the payment. The service provider can then display a transaction receipt on the transaction-specific web page, in step 312.

FIGS. 5-20 are screenshots illustrating an embodiment of the present invention. For example, FIG. 5 shows a screenshot of a payment page for a web-based merchant (e.g., “Cute Puppies”). In FIG. 5, the consumer is given the option to select between multiple POS terminals to complete their purchase transaction. FIG. 6 shows a screenshot after the consumer has selected 7-ELEVEN™ as their POS terminal. In FIG. 6, the consumer is given the option to print a token ID, or have a token ID sent to their mobile device by clicking the “Use Mobile” icon. FIG. 7 shows a print-out of the token ID and transaction instructions if the user clicks the “Print” icon shown in FIG. 6. However, if the consumer clicks the “Use Mobile” icon, the consumer is prompted to enter their e-mail or mobile number, as shown in the screenshot of FIG. 8. Alternatively, the consumer's contact information may be provided by other means, such as directly from a database provided by the merchant, POS, and/or service provider. As such, the consumer's contact information can merely be “confirmed” by the consumer.

FIG. 9 shows a mobile screenshot of an SMS text message sent to the consumer with a transaction-specific URL that is linked to a transaction-specific web page. The consumer, however, is given the option of proceeding via a back-and-forth SMS text message exchange with the service provider. For example, if the consumer's mobile device does not have “browser capability,” the consumer can send a return text of “No,” in which case the service provider will send SMS text message instructions, as shown in FIGS. 10 and 11. If the consumer clicks on the transaction-specific URL, the process proceeds to the screen shown in FIG. 12. More specifically, FIG. 12 shows the consumer accessing the transaction-specific web page on their mobile device (e.g., on a mobile browser or dedicated mobile application (or “app”)). The transaction-specific web page provides transaction instructions for the consumer to complete the transaction. For example, FIG. 12 shows a transaction-specific web page with a prompt asking the user to select their POS terminal, or enter a zip code or address to locate local POS terminals.

Once the consumer has selected a local POS terminal, the transaction-specific web page is refreshed by the service provider to show additional transaction instructions. When the consumer is at the POS terminal, they can click on the icon “At Cashier” to proceed to POS instructions, as shown in FIG. 14. In other words, FIG. 14 shows transaction instructions for the POS terminal. In FIG. 14, the token ID is displayed in the form of a barcode. The POS terminal can then scan the barcode to initiate communication with the service provider. In other words, the barcode is used as a means for initiating the transfer of presentment data to the service provider.

If, however, the POS terminal attendant is unsure of how to process the transaction, a “Need Help? Tap Here” icon is provided on the transaction-specific web page. If the consumer or POS terminal attendant clicks on the “Need Help? Tap Here” icon, a transaction-specific instruction set is provided by the service provider on the transaction-specific web page. The service provider can select the transaction-specific instruction set based on the POS terminal selected by the consumer. FIGS. 15-19 illustrate screen shots of a transaction-specific instruction set. Each screenshot shown in FIGS. 15-19 is customized to the consumer's transaction. For example, FIG. 15 illustrates a terminal that matches the POS terminal. FIG. 15 also illustrates the transaction amount. FIGS. 16-19 then show ensuing steps to be performed by the POS terminal attendant.

After the consumer has made a payment in accordance with the transaction instructions, and the service provider has validated the payment, the service provider can refresh (or otherwise update) the transaction-specific web page to show a receipt for the transaction. The receipt text can provide additional instructions and/or promotions for the consumer. The receipt text can also mimic the receipt text that would be (or is) otherwise provided by the POS terminal.

In one embodiment, there is provided a computer-implemented method for facilitating a payment for goods or services between an online merchant and a consumer. The method calls for the consumer to provide a purchase request on a web-based interface, and the payment for the purchase request at a consumer-selected point-of-sale (POS) terminal that is local to the consumer and remote to the merchant. The purchase request may be received at a service provider processing unit, from the merchant's web based interface, based on directives from a merchant server. The purchase request may be received at a service provider processing unit, from the merchant's web-based interface, via an application programming interface (API) call from the merchant server. As would be appreciated by one of skill in the art, alternatives to web-based interfaces are within the scope of the present invention. In other words, any means for communicating and/or transmitting information from the consumer and/or merchant may be employed; for example, an application (i.e., “app”) on a mobile device, an interactive voice response (IVR) system, a third-party database, an operator-assisted phone call, or any other equivalent means.

The method comprises a service provider processing unit performing the steps of: (a) receiving the purchase request from the web-based interface; (b) staging a transaction in a database by creating a database entry linking one or more transaction instructions to the consumer; (c) creating a transaction-specific unique reference locator (URL) linked to a transaction-specific web page for displaying the one or more transaction instructions; (d) providing the consumer with a web-based prompt to enter their contact information; (e) receiving the consumer's contact information and linking the contact information to the database entry; and (f) using the provided contact information to send the transaction specific URL to the consumer. The consumer may provide their contact information in the form of an e-mail address or a telephone number. The transaction-specific URL may be sent to the consumer in an e-mail or a short message service (SMS) text message. Whereupon the consumer clicking the transaction-specific URL on a mobile device, the service provider processing unit further performs the steps of: (g) receiving a user-agent string identifying the mobile device; (h) assessing compatibility of the mobile device based on the user-agent string; (i) receiving a geolocation from the mobile device; (j) identifying one or more POS terminals local to the consumer based on geolocation; and (k) providing the consumer, via the transaction-specific web page, a list of the one or more POS terminals. Whereupon the consumer's selection of a POS terminal for providing the payment, the service provider processing unit further performing the step of: (l) displaying a token ID on the transaction-specific web page, wherein the token ID is linked to the database entry and is used to initiate data communication between the consumer-selected POS terminal and the service provider processing unit. The token ID may be in a form selected from the group consisting of: a barcode, a pin number, and a QR code.

In alternative embodiments, the consumer's contact information may be obtained via an interface such as an application (i.e., “app”) on a mobile device, an IVR system, a third-party database, an operator-assisted phone call, or any other equivalent means for sharing and/or obtaining information from the consumer.

The method may further comprise: (m) providing the consumer-selected POS terminal with a communication interface such that the consumer-selected POS terminal can confirm that the consumer has presented the token ID and provided the payment to the POS terminal; and the service provider processing unit then performing the steps of: (n) receiving confirmation that the consumer has presented the token ID and the payment to the POS terminal; (o) verifying that the payment is in accordance with the one or more transaction instructions; and/or (p) displaying a transaction receipt on the transaction specific web page. The method may further include the step of (q) notifying the merchant that the consumer has provided the payment; and/or (r) the service provider processing unit performing the step of selecting the form of the token ID based on the POS terminal selected by the consumer.

In another embodiment, there is provided a method for facilitating a transaction between a merchant and a consumer, wherein the consumer provides a payment for the transaction at a consumer-selected POS terminal. The method includes a service provider processing unit performing the steps of: (a) receiving a service request; (b) staging a transaction in a database by creating a database entry linking one or more transaction instructions to the consumer; (c) creating a transaction-specific URL linked to a transaction-specific web page for displaying the one or more transaction instructions; and (d) using consumer contact information to send the transaction-specific URL to the consumer. Whereupon the consumer accesses the transaction specific web page from a mobile device, via the transaction-specific URL, the service provider processing unit further performs the steps of: (e) identifying one or more available POS terminals; and (f) displaying the one or more available POS terminals on the transaction-specific web page. Whereupon the consumer selects a POS terminal for providing the payment, the service provider processing unit performs the step of: (g) displaying a token ID on the transaction-specific web page, wherein the token ID is linked to the database entry and is used to initiate data communication between the consumer-selected POS terminal and the service provider processing unit. The token ID may be in a form selected from the group consisting of: a barcode, a pin number, and a QR code. The service provider processing unit may further perform the steps of: (h) receiving confirmation that the consumer has presented the token ID and the payment to the POS terminal; (i) displaying a transaction receipt on the transaction-specific web page; and/or (j) notifying the merchant that the consumer has provided the payment.

In yet another embodiment, there is provided a method for facilitating a payment between a merchant and a consumer, wherein the consumer provides the payment at a consumer-selected POS terminal. The method comprises a service provider processing unit performing the steps of: (a) staging a transaction in a database by creating a database entry linking one or more transaction instructions to the consumer; (b) creating a transaction-specific URL linked to a transaction-specific web page for displaying the one or more transaction instructions; and (c) sending the transaction-specific URL to the consumer via a SMS text message. Whereupon the consumer clicks the transaction-specific URL on a mobile device, the service provider processing unit performs the steps of: (d) displaying the one or more transaction instructions on the transaction-specific web page; and (e) displaying a token ID on the transaction-specific web page, wherein the token ID is linked to the database entry and is used to initiate data communication between the consumer-selected POS terminal and the service provider processing unit. The token ID may be in a form selected from the group consisting of: a barcode, a pin number, and a QR code. The method may further comprise the service provider processing unit then performing the steps of: (f) receiving confirmation that the consumer has presented the token ID and the payment to the POS terminal; (g) displaying a transaction receipt on the transaction-specific web page; (h) notifying the merchant that the consumer has provided the payment; and/or (i) selecting the form of the token ID based on the POS terminal selected by the consumer.

In still another embodiment, there is provided a method for facilitating a cash payment for goods/services, wherein the consumer provides the payment at a POS terminal. The method comprises a service provider processing unit performing the steps of: (a) obtaining a consumer's contact information; (b) creating a transaction-specific URL linked to a transaction-specific web page for displaying the one or more transaction instructions; and (c) sending the transaction-specific URL to the consumer. Whereupon the consumer clicks the transaction-specific URL on a mobile device, the service provider processing unit performs the step of: (d) displaying the one or more transaction instructions on the transaction-specific web page. Whereupon the consumer indicates they are present at the POS terminal, the service provider processing unit performs the step of: (e) displaying a token ID on the transaction-specific web page, wherein the token ID is used to initiate data communication between the POS terminal and the service provider processing unit. The token ID may be in a form selected from the group consisting of: a barcode, a pin number, and a QR code. The method may further comprise the service provider processing unit then performing the steps of: (f) receiving an amount of payment received at the POS terminal; (g) displaying a transaction receipt on the transaction-specific web page; and/or (h) crediting a consumer account, debit card, pre-paid card, loan, or equivalent account, based on the amount of payment received at the POS terminal.

In yet another embodiment, there is provide a system and method for facilitating a cash payment for goods or services, wherein a consumer provides the payment at a POS terminal. The system and method include a service provider processing unit performing the steps of: (a) creating a transaction-specific display prompt for displaying the one or more transaction instructions; (b) sending the consumer a transaction-specific link to the transaction-specific display prompt; (c) displaying the one or more transaction instructions on the transaction-specific display prompt; and (d) displaying a token ID on the transaction-specific display prompt, wherein the token ID is used to initiate data communication between the POS terminal and the service provider processing unit. The system and method may further include the service provider processing unit performing the steps of: (e) receiving an amount of payment received at the POS terminal; (f) displaying a transaction receipt on the transaction-specific display prompt; (g) crediting a consumer account, debit card, pre-paid card, or loan, based on the amount of payment received at the POS terminal. The system and method presented can be implemented on a browser-based mobile prompt, or an application specific display interface.

In one embodiment, communication between the various parties and components of the present invention is accomplished over a network consisting of electronic devices connected either physically or wirelessly, wherein digital information is transmitted from one device to another. Such devices (e.g., end-user devices and/or servers) may include, but are not limited to: a desktop computer, a laptop computer, a handheld device or PDA, a cellular telephone, a set top box, an Internet appliance, an Internet TV system, a mobile device or tablet, or systems equivalent thereto. Exemplary networks include a Local Area Network, a Wide Area Network, an organizational intranet, the Internet, or networks equivalent thereto. The functionality and system components of an exemplary computer and network are further explained in conjunction with FIG. 4, below.

In one embodiment, the invention is directed toward one or more computer systems capable of carrying out the functionality described herein. For example, FIG. 4 is a schematic drawing of a computer system 400 used to implement the methods presented above. Computer system 400 includes one or more processors, such as processor 404. The processor 404 is connected to a communication infrastructure 406 (e.g., a communications bus, cross-over bar, or network). Computer system 400 can include a display interface 402 that forwards graphics, text, and other data from the communication infrastructure 406 (or from a frame buffer not shown) for display on a local or remote display unit 430.

Computer system 400 also includes a main memory 408, such as random access memory (RAM), solid state device, and/or hard drive. Computer system 400 may also include a secondary memory 410. The secondary memory 410 may include, for example, a hard disk drive 412 and/or a removable storage drive 414, representing a floppy disk drive, a magnetic tape drive, an optical disk drive, flash memory device, universal serial bus (USB) device, etc. The removable storage drive 414 reads from and/or writes to a removable storage unit 418. Removable storage unit 418 represents a floppy disk, magnetic tape, optical disk, flash memory device, universal serial bus (USB) device, etc., which is read by and written to by removable storage drive 414. As will be appreciated, the removable storage unit 418 includes a computer usable storage medium having stored therein computer software, instructions, and/or data.

In alternative embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow computer software, instructions, and/or data to be transferred from the removable storage unit 422 to computer system 400.

Computer system 400 may also include a communications interface 424. Communications interface 424 allows computer software, instructions, and/or data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428 which may be electronic, electromagnetic, optical or other signals capable of being received by communications interface 424. These signals 428 are provided to communications interface 424 via a communications path (e.g., channel) 426. This channel 426 carries signals 428 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to all nontransitory computer-readable media; such as removable storage drive 414, removable storage units 418, 422, a hard disk installed in hard disk drive 412, or equivalent computer-readable media with the exclusion of propagating signals. These computer program products provide computer software, instructions, and/or data to computer system 400. These computer program products also serve to transform a general purpose computer into a special purpose computer programmed to perform particular functions, pursuant to instructions from the computer program products/software. Embodiments of the present invention are directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features of the present invention, as discussed herein. In particular, the computer programs, when executed, enable the processor 404 to perform the features of the presented methods. Accordingly, such computer programs represent controllers of the computer system 400. Where appropriate, the processor 404, associated components, and equivalent systems and sub-systems thus serve as “means for” performing selected operations and functions. Such “means for” performing selected operations and functions also serve to transform a general purpose computer into a special purpose computer programmed to perform said selected operations and functions.

In an embodiment where the invention is implemented using software, the software may be stored in a computer program product and loaded into computer system 400 using removable storage drive 414, interface 420, hard drive 412, communications interface 424, or equivalents thereof. The control logic (software), when executed by the processor 404, causes the processor 404 to perform the functions and methods described herein.

In another embodiment, the methods are implemented primarily in hardware using, for example, hardware components such as application specific integrated circuits (ASICs). Implementation of the hardware state machine so as to perform the functions and methods described herein will be apparent to persons skilled in the relevant art(s). In yet another embodiment, the methods are implemented using a combination of both hardware and software.

Embodiments of the invention, including any systems and methods described herein, may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

For example, in one embodiment, there is provided a computer-readable storage medium for facilitating a payment for goods or services between an online merchant and a consumer. The computer-readable storage medium includes instructions executable by at least one processing device that, when executed, cause the processing device to: (a) receive a purchase request from the online merchant's web-based interface; (b) stage a transaction in a database by creating a database entry linking one or more transaction instructions to the consumer; (c) create a transaction-specific URL linked to a transaction-specific web page for displaying the one or more transaction instructions; (d) provide the consumer with a web-based prompt to enter their contact information; (e) receive the consumer's contact information and linking the contact information to the database entry; and (f) use the provided contact information to send the transaction specific URL to the consumer. Whereupon the consumer clicks the transaction-specific URL on a mobile device, the computer-readable storage medium includes instructions that cause the processing device to: (g) receive a user-agent string identifying the mobile device; (h) assess the compatibility of the mobile device based on the user-agent string; (i) receive a geolocation from the mobile device; (j) identify one or more POS terminals local to the consumer based on geolocation; and (k) provide the consumer, via the transaction-specific web page, a list of the one or more POS terminals. Whereupon the consumer selects of a POS terminal for providing the payment, the computer-readable storage medium includes instructions that cause the processing device to: (l) display a token ID on the transaction-specific web page, wherein the token ID is linked to the database entry and is used to initiate data communication between the consumer-selected POS terminal and the service provider processing unit; (m) provide the consumer-selected POS terminal with a communication interface such that the consumer-selected POS terminal can confirm that the consumer has presented the token ID and provided the payment to the POS terminal; (n) receive confirmation that the consumer has presented the token ID and the payment to the POS terminal; (o) verify that the payment is in accordance with the one or more transaction instructions; (p) display a transaction receipt on the transaction-specific web page; (q) notifying the merchant that the consumer has provided the payment; and/or (r) select the form of the token ID based on the POS terminal selected by the consumer. The token ID may be a form selected from the group consisting of: a barcode, a pin number, and a QR code. The purchase request may be received from the web-based interface based on directives from a merchant server. The purchase request may be received via an application programming interface (API) call from a merchant server. The consumer may provide their contact information in the form of an e-mail address or a telephone number. The transaction-specific URL may be sent to the consumer in an e-mail or a SMS text message.

In another embodiment, there is provided a computer-readable storage medium for facilitating a transaction between a merchant and a consumer, wherein the consumer provides a payment for the transaction at a consumer-selected point-of-sale (POS) terminal. The computer-readable storage medium includes instructions executable by at least one processing device that, when executed, cause the processing device to: (a) receive a service request; (b) stage a transaction in a database by creating a database entry linking one or more transaction instructions to the consumer; (c) create a transaction specific URL linked to a transaction-specific web page for displaying the one or more transaction instructions; and (d) use consumer contact information to send the transaction-specific URL to the consumer. Whereupon the consumer accesses the transaction specific web page from a mobile device, via the transaction-specific URL, the computer-readable storage medium includes instructions that cause the processing device to: (e) identify one or more available POS terminals; and (f) display the one or more available POS terminals on the transaction-specific web page. Whereupon the consumer selects a POS terminal for providing the payment, the computer-readable storage medium includes instructions that cause the processing device to: (g) display a token ID on the transaction-specific web page, wherein the token ID is linked to the database entry and is used to initiate data communication between the consumer-selected POS terminal and the service provider processing unit; (h) receive confirmation that the consumer has presented the token ID and the payment to the POS terminal; (i) display a transaction receipt on the transaction-specific web page; and/or (j) notifying the merchant that the consumer has provided the payment. The token ID may be in a form selected from the group consisting of: a barcode, a pin number, and a QR code.

In another embodiment, there is provided a computer-readable storage medium for facilitating a payment between a merchant and a consumer, wherein the consumer provides the payment at a consumer-selected point-of-sale (POS) terminal. The computer-readable storage medium includes instructions executable by at least one processing device that, when executed, cause the processing device to: (a) stage a transaction in a database by creating a database entry linking one or more transaction instructions to the consumer; (b) create a transaction-specific unique reference locator (URL) linked to a transaction-specific web page for displaying the one or more transaction instructions; and (c) send the transaction-specific URL to the consumer via a short message service (SMS) text message. Whereupon the consumer clicking the transaction-specific URL on a mobile device, the computer-readable storage medium includes instructions that cause the processing device to: (d) display the one or more transaction instructions on the transaction-specific web page; and (e) display a token ID on the transaction-specific web page, wherein the token ID is linked to the database entry and is used to initiate data communication between the consumer-selected POS terminal and the service provider processing unit. The computer-readable storage medium may further include instructions that cause the processing device to: (f) receive confirmation that the consumer has presented the token ID and the payment to the POS terminal; (g) display a transaction receipt on the transaction-specific web page; (h) notify the merchant that the consumer has provided the payment; and/or (i) select the form of the token ID based on the POS terminal selected by the consumer. The token ID may be in a form selected from the group consisting of: a barcode, a pin number, and a quick response (QR) code.

In still another embodiment, there is provided a computer-readable storage medium for facilitating a cash payment by a consumer, wherein the consumer provides the payment at a consumer-selected point-of-sale (POS) terminal. The computer-readable storage medium includes instructions executable by at least one processing device that, when executed, cause the processing device to: (a) obtain a consumer's contact information; (b) create a transaction-specific URL linked to a transaction-specific web page for displaying the one or more transaction instructions; (c) send the transaction specific URL to the consumer; (d) display the one or more transaction instructions on the transaction-specific web page; (e) display a token ID on the transaction-specific web page, wherein the token ID is used to initiate data communication between the POS terminal and the service provider processing unit; (f) receive an amount of payment received at the POS terminal; (g) display a transaction receipt on the transaction-specific web page; and/or (h) credit a consumer account, debit card, pre-paid card, loan, or equivalent account, based on the amount of payment received at the POS terminal.

One may use various processes in different situations to handle payments. For example, in one type of situation, one may seek to tie evidence of a payment to a specific device used for payment. As another example, one may seek to substitute remote payment processing for a cashier.

FIG. 21 illustrates processing a payment in an embodiment. In such an embodiment, one seeks to process a payment such that a secure option exists for finding evidence of payment. Process 2100 involves making an order, such as through a website, and then requesting that the order be paid for through cash processing. In such an instance, the typical processing system of FIGS. 1-20 can handle the transaction. However, such an order may be made on one device (e.g. a tablet 2120 or a laptop 2130, for example) and actually paid for with a different device (e.g. a mobile phone 2110). Alternatively, the order may be handled on the phone 2110, but may also be simultaneously accessible on other devices, such as table 2120, laptop 2130, and other potential devices. In particular, if one uses a web-based account, that account may be accessible through a variety of avenues, consistent with general access to web-based accounts.

Thus, one may place an order using any of devices 2110, 2120 and 2130. Next, a user takes a single device (e.g. phone 2110) to a point-of-sale device (e.g. POS device 2140, for example) to arrange for payment. POS device 2140 may represent any number of different types of POS devices, a scanner is displayed to illustrate the concept. Payment is arranged using POS device 2140 and mobile phone 2110. At that point, mobile device 2110 is marked as the device used for payment, allowing it to display an active payment screen, or other information specific to redeeming a transaction, for example. Other devices (e.g. 2120 and 2130) can access status information about the payment, but do not get access to potentially sensitive information, such as an electronic boarding pass or a redeemable receipt.

A process for such a transaction may be further understood with reference to FIG. 22. FIG. 22 illustrates a process of handling a payment in an embodiment. Process 2200 provides for processing of a payment with specific evidence of the payment provided only to a specified device. Process 2200 integrates with processes and embodiments of FIGS. 1-20 above, and represents one option for achieving the result discussed with respect to FIG. 21.

Process 2200 initiates at module 2210 with a request to pay for a transaction or order. This request may be made at a merchant that accepts cash payment, for example. At module 2220, payment information is displayed, and at module 2230, a payment is made and processed. At module 2240, the payment is acknowledged, indicating the payment was accepted. At module 2250, active payment information is displayed, such as a boarding pass, event ticket or a receipt with information specific to receipt of related goods and services. Additionally, in some embodiments, at module 2255, a receipt is provided in paper form to a customer.

Alternatively, at module 2250, a user may provide information about where to send active payment information (e.g. to a mobile device with a phone number or to an email account, for example). Thus, the active payment information may be sent to an account which the user trusts as reasonably secure, or to a device the user considers secure. This may be accomplished by displaying a prompt for the user to enter information about where to send active payment information.

Ultimately, a proper device is selected as the appropriate place to display active payment information. Additional requests to view active payment information or simply to view status of payment can be received from multiple devices (e.g. at module 2260). At module 2270, a check is made of the device to determine if it is the proper device. If the proper device is making the request, active payment information is sent back, including information such as boarding pass, QR code or bar code used to redeem goods and/or services. If the device making the request is an improper device (e.g. a tablet computer, where a mobile phone was used to process the payment), then at module 2290, status information for the order or transaction is displayed (showing that it was paid, for example). However, no active payment information is provided. Any information displayed at module 2290 may be expected to be inactive payment information, such as status information or transaction details which should not allow for redemption of associated goods and services.

Marking a device as the proper device can be handled in a variety of ways. For example, at module 2240 or 2250, a cookie or similar file may be provided or modified on the proper device, showing that device is the correct one to view the payment. Alternatively, a unique identifier for the device may be recorded at payment time (e.g. a MAC ID or a global unique identifier), with the identifier then recorded within a system database (not on the proper device) for comparison purposes at module 2270. In the instance of prompting for a device to receive active payment information, that device can be similarly identified with a cookie or identifier. Likewise, where an email is sent with active payment information, that email can be keyed to the first device where it is opened, or can be tied to the device used to make the payment in the first place. Alternatively, the email can be used to always access active payment information, regardless of device, but other attempts to access payment information (e.g. through a payment account) may be regarded as using an improper device. In such an instance, the check of module 2270 is a check of whether the link to the payment information comes through the designated email or through some other route.

Payments of various types generally involve some common elements. FIG. 23 illustrates interactions involved in a payment in some embodiments. As illustrated, consumer 2315 initially approaches merchant 2310 about a purchase. This may involve a local purchase of goods or services, or a web-based purchase, for example. Merchant 2310 issues a token 2330, which may be used at payment location 2320 to arrange for a specified payment. Payment location 2320 may be a place that accepts cash payments, for example, or may simply be any payment processing location. With a payment processed, payment evidence 2340 is issued and makes its way to merchant 2310. Then, goods and/or services may be redeemed from merchant 2310.

An example of interactions in this pattern involves use of a merchant which does not desire to have an onsite payment processing operation (e.g. a cash register or credit card processing system). One can, for example, approach a hotel about renting a room. Rather than accepting payment, a merchant 2310 can issue a token 2330, which can be taken personally or electronically to a payment location 2320. FIG. 24 illustrates processing a payment in another embodiment such as this type of situation. A customer visits a merchant at module 2410. At module 2420, the customer receives payment information. This may come in the form of a slip of paper with tokenized payment information, or in some electronic form, as described and illustrated above. At module 2430, the customer goes to pay, such as at a payment location 2320. At module 2440, payment evidence is received. At module 2450, the customer goes to the merchant. At module 2460, the merchant validates that the customer made the payment in question. At module 2470, the customer (e.g. 2315) receives goods and/or services (e.g. 2350) from the merchant (e.g. 2310).

In some circumstances, the customer may receive a printed receipt showing payment evidence at module 2440, and the merchant may check the receipt to validate payment at module 2460. In other circumstances, the merchant may receive payment evidence directly, requiring the customer to then provide evidence that the customer was the one involved in the transaction (such as through the initial token information). Moreover, the token information and payment evidence may typically go through a payment system, rather than traveling directly between the merchant and payment processor, for example. Additionally, the token information can be tied to a specific device, such as through scanning of a barcode or QR code, or through use of latitude and longitude (location of the device) and access to a specified website, for example. The payment information received by the merchant may include something along the lines of an email or SMS message, for example, or may include information available through an account (e.g. a website account) accessible by the merchant.

Also, the interaction between the customer and the merchant may be at a remove in some instances. For example, a merchant may transmit a token to a customer in the form of some sort of hotel room key. Once payment is made, the key is then activated for use at the hotel room based on merchant validation of the payment, and use of the key by the customer allows for access to the hotel room (redemption of services). As another example, periodic payments, such as on a car, may be made using a series of payment tokens or a reusable payment token. In such an instance, the customer continues to receive use of the appropriate goods and services based on not having the car repossessed. One may also use this system to implement a layaway process with periodic payments to a payment processor. In each of these examples, it is possible to process all payments at the payment processor (e.g. a local convenience store). This allows one to eliminate the need for a local cashier at some businesses, such as some hotels or car dealerships. In turn, one can reduce the possibility of some robbery or crime, due to the lack of a cash register, safe, etc. This potentially means that one no longer needs bullet-proof glass and other expensive aspects of such an installation. Also, one can take a variety of types of payments (e.g. cash, credit card, EFT, etc.) based on what the payment processor will handle.

One example of what may be used to outsource the cash register is a payment stub. FIG. 25 illustrates an example of a payment stub which may be used in some embodiments. Receipt book 2500 includes a cover 2510 and a set of receipts 2520. Each receipt 2520 includes a specific identifier 2530. As illustrated, the identifier 2530 is alphanumeric, but a more unique barcode or QR code may be used as the identifier 2530. Each receipt book 2500 also includes a unique identifier 2540, illustrated here as a barcode.

One can provide (or sell) receipt books to merchants, allowing the merchants to register the receipt book with the overall payment processing system. Once registered, the receipt book is associated with a merchant account, allowing for individual receipts in the receipt book to be used for payment to the merchant through a retail location or payment processor. Note that the receipt then functions as a receipt for customer records after payment is finished. The receipt can also be used to provide proof of payment or allow a merchant to validate payment. Thus, a merchant such as a hotel can scan a receipt upon return of a customer from a retail location, and based on verification of a payment received corresponding to the specific receipt, the customer can be provided access to the usual privileges and amenities of the hotel.

Handling the backend aspects of the payment book (or receipt or coupon book) involves an additional process as well. FIG. 26 illustrates a process of handling transactions for a merchant account with a payment book. Process 2600 initiates when a merchant purchases a payment book at module 2610 (although this may be free). At module 2620, the merchant registers the payment book, associating the payment coupons or receipts with the account of the merchant. This may involve going to a website and registering the book, or may be based on information provided by the merchant upon purchase or free receipt of the payment book.

Module 2620 may further involve some sort of validation step. For example, a part of the payment for the payment book may be refunded to the merchant into an account specified by the merchant for receipt of payments associated with the payment book. In such an instance, the merchant may need to verify one, two or more transactions in the form of deposits of funds into the merchant account, such as by inspecting the amounts deposited and providing those amounts in the validation process.

At module 2630, the merchant provides a coupon (or receipt) to a customer seeking to purchase goods or services. At module 2640, the merchant receives payment evidence, such as may result from the customer taking the coupon to a retail location. Some of the examples of evidence of such a transaction discussed with regard to FIG. 24 may be used, for example. Note that if a merchant account is not validated at module 2620 (or the account is changed), a similar type of validation process may be performed with funds in the transaction represented by modules 2630 and 2640, for example.

After payment by the customer, the merchant may further receive a request for the goods or services from the customer at module 2650 (e.g. the customer requests his room or comes to pick up a car, for example). The merchant may then validate payment at module 2660, such as by checking for a message about payment, checking the unique identifier of the coupon or receipt, or otherwise verifying that payment has been received. At module 2670, the merchant fulfills the request of the customer.

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible. Further, each system component and/or method step presented should be considered a “means for” or “step for” performing the function described for said system component and/or method step. As such, any claim language directed to a “means for” or “step for” performing a recited function refers to the system component and/or method step in the specification that performs the recited function, as well as equivalents thereof.

It is to be appreciated that the Detailed Description section, and not any Summary and Abstract sections, is intended to be used to interpret the claims. Any Summary and Abstract sections may set forth one or more, but not all exemplary embodiments of the present invention as contemplated by the inventor(s), and thus, are not intended to limit the present invention and the appended claims in any way.

One skilled in the art will appreciate that although specific examples and embodiments of the system and methods have been described for purposes of illustration, various modifications can be made without deviating from present invention. For example, embodiments of the present invention may be applied to many different types of databases, systems and application programs. Moreover, features of one embodiment may be incorporated into other embodiments, even where those features are not described together in a single embodiment within the present document.

1. A method for facilitating bill payment comprising the steps of:
generating with a processor of a payment processor system a unique token;
providing with a communications interface of the payment processor system the unique token to a user;
receiving with the communications interface of the payment processor system an indication from a retail location that the unique token was used on a first user device in conjunction with a payment associated with the unique token at a point-of-sale;
marking with the processor and communications interface of the payment processor system the first user device as associated with the first unique token;
providing with the communications interface of the payment processor system active payment information to the first user device;
receiving with the communications interface of the payment processor system a request for payment information from a second user device; and
providing with the communications interface of the payment processor system inactive payment information to the second user device.

2. The method of claim 1 wherein marking the first user device includes providing a cookie to the first user device.

3. The method of claim 1 wherein marking the first user device includes receiving and recording a unique identifier for the first user device.

4. The method of claim 3 wherein marking the first user device includes providing a cookie to the first user device.

5. The method of claim 1 wherein the active payment information includes a boarding pass.

6. The method of claim 1 wherein the active payment information includes a redeemable ticket to an event.

7. The method of claim 1 wherein the active payment information includes a redeemable receipt.

8. The method of claim 1 further comprising:
transmitting with the communications interface of the payment processor system a request for destination information for the active payment information to the first user device;
receiving with the communications interface of the payment processor system the destination information;
verifying with the processor of the payment processor system that the destination information came from the first user device; and
sending with the communications interface of the payment processor system the active payment information to a destination designated by the destination information.

9. A method for facilitating bill payment comprising the steps of:
requesting with a communications interface of a payment processor system destination information from a user for active payment information;
receiving with the communications interface of the payment processor system destination information from the user for the active payment information;
providing with a processor and the communications interface of the payment processor system a unique token to a user;
receiving with the communications interface of the payment processor system an indication from a retail location that the unique token was used on a first user device in conjunction with payment associated with the unique token at a point-of-sale;
sending with the communications interface of the payment processor system the active payment information to a destination designated by the destination information from the user;
receiving with the communications interface of the payment processor system a request for payment information from the second user device; and
providing with the processor and the communications interface of the payment processor system inactive payment information to the second user device.

10. The method of claim 9, further comprising:
marking with the processor and the communications interface of the payment processor system the destination information as associated with the first user device;
providing with the communications interface of the payment processor system active payment information to the first user device responsive to a request from the first user device.

11. A payment processor system comprising:
a processor configured to generate a unique token;
a communications interface configured to transmit the unique token to a user and configured to receive an indication from a retail location that the unique token was used on a first user device in conjunction with a payment associated with the unique token at a point-of-sale;
wherein, the processor and communications interface are configured to mark the first user device as associated with the first unique token;
the communications interface is configured to transmit the active payment information to the first user device, receive a request for payment information from a second user device, and provide inactive payment information to the second user device.

12. The system of claim 11 the processor and communications interface are configured to provide a cookie to the first user device.

13. The system of claim 11 the processor and communications interface are configured to receive and record in memory of the payment processor system a unique identifier for the first user device.

14. The system of claim 13 the processor and communications interface are configured to provide a cookie to the first user device.

15. The system of claim 11 wherein the active payment information includes a boarding pass.

16. The system of claim 11 wherein the active payment information includes a redeemable ticket to an event.

17. The system of claim 11 wherein the active payment information includes a redeemable receipt.

18. The system of claim 11 wherein:
the communications interface is configured to transmit a request for destination information for the active payment information to the first user device and receive the destination information;
the processor is configured to verify that the destination information came from the first user device; and
the communications interface is configured to send the active payment information to a destination designated by the destination information.
